(19) United States
(12) Patent Application Publication
(10) Pub. No.: US 2006/0064190 A1
(43) Pub. Date: Mar. 23, 2006

(54) Method and system for dispatching semiconductor component during manufacture

(75) Inventors: Ming Wang, Zhonghe City (TW); James Cheng, Hsinchu City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 10/944,643

(22) Filed: Sep. 17, 2004

(51) Int. Cl. G06F 19/00

(52) U.S. Cl. 700/102; 700/103

(57) ABSTRACT

A technique for dispatching semiconductor components for processing is disclosed. The technique includes providing a plurality of lots of semiconductor components. The technique also includes providing a plurality of rules, each including one or more conditions. The technique further includes determining which of the plurality of rules is applicable to a particular lot, and eliminating rules that are not applicable to a particular lot, thus forming a plurality of remaining rules for each particular lot. The technique still further includes applying the plurality of remaining rules to the lots of semiconductor components. If a rule applied to a particular lot activates, processing of the particular lot is inhibited.

### FIELD OF DISCLOSURE

The present disclosure relates generally to the field of semiconductor manufacturing and, more particularly, to a method and system for dispatching semiconductor components (e.g., wafers, integrated circuits (“ICS”)) for processing.

### BACKGROUND

The semiconductor industry has experienced rapid growth. For example, technological advances in semiconductor component materials and design have produced generations of integrated circuits(“ICs”) where each generation has smaller and more complex circuits than the previous generation. However, these advances have increased the complexity of processing and manufacturing ICs and, for these advances to be realized, similar developments in IC processing and manufacturing have been needed. For example, an IC is formed by creating one or more devices (e.g., circuit components) on a substrate using a fabrication process. As the geometry of such devices is reduced to the submicron or deep submicron level, the IC's active device density (i.e., the number of devices per IC area) and functional density (i.e., the number of interconnected devices per IC area) has become limited by the manufacturing process.

One area of concern in the manufacturing process is management of manufacturing resources (e.g., equipment), including techniques associated with dispatching semiconductor components (e.g., wafers and ICs) for a processing by a specific manufacturing resource. A conventional dispatching technique causes various problems including inefficiency.

Accordingly, what is needed is a method and system without the disadvantages described above.

### BRIEF DESCRIPTION OF THE DRAWINGS

FIG. 1 is a block diagram of a system according to the illustrative embodiment.

FIG. 2 is a more detailed block diagram of the system of FIG. 1.

FIG. 3 is a block diagram of a representative one of the computing systems of FIG. 2.

FIG. 4 is a block diagram of a dispatch system.

FIG. 5 is a block diagram of an inhibition system of FIG. 4.

FIG. 6 is a table of rules included by the inhibition system of FIG. 5.

FIG. 7 is a flow chart of operations performed by a search engine of FIG. 4.

### DETAILED DESCRIPTION

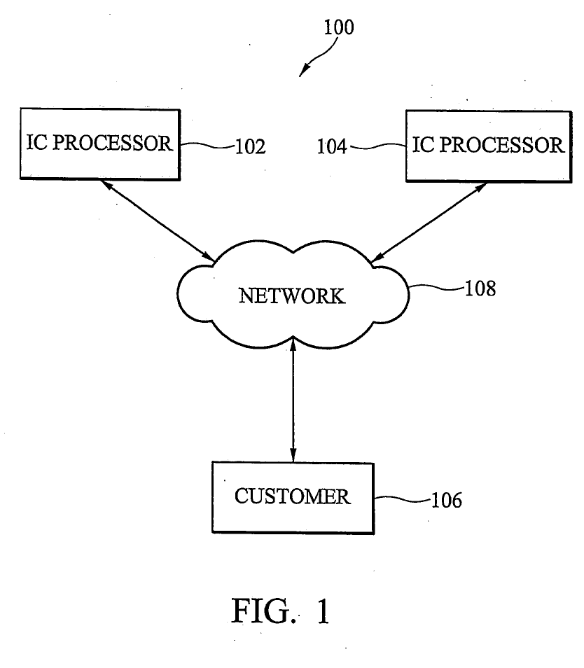

FIG. 1 is a block diagram of a system, indicated generally at 100 according to the illustrative embodiment. System 100 includes: an integrated circuit (“IC”) processor 102, an IC processor 104, and a customer 106. In one example, the IC processor 102 is a semiconductor component (e.g., wafer or IC) design/fabrication company, and the IC processor 104 is an IC testing/packaging company. Accordingly, the IC processor 102 designs and fabricates IC's, and IC processor 104 tests and packages the IC's for delivery to a customer (e.g., the customer 106). The customer 106 is a purchaser of the IC's designed/fabricated by the IC processor 102 and tested/packaged by the IC processor 104.

In alternative embodiments, processes performed by each of the IC processors 102 and 104, differ from the above description. For example, in a first alternative embodiment, the IC processor 102 performs all of the processes (i.e., design, fabricate, test, and package) of IC manufacturing. In a second alternative embodiment, the IC processor 104 performs all such processes. In a third alternative embodiment, the IC processor 102 designs IC's and the IC processor 104 contributes to the manufacturing processes by fabricating, testing, and packaging the IC's.

Referring again to the illustrative embodiment depicted in FIG. 1, each of the IC processor 102, the IC processor 104, and the customer 106 includes one or more respective computing systems. Also, each of the computing systems of the IC processor 102, the IC processor 104, and the customer 106 includes a respective information handling system (“IHS”), such as a personal computer, a personal digital assistant, a pager, or a cellular phone.

Moreover, the system 100 includes a network 108 (e.g., a Transport Control Protocol/Internet Protocol (“TCP/IP”), such as the Internet or an intranet). Accordingly, each of computing systems of the IC processor 102, the IC processor 104, and the customer 106 is equipped with a respective network interface for communicating with the network 108.

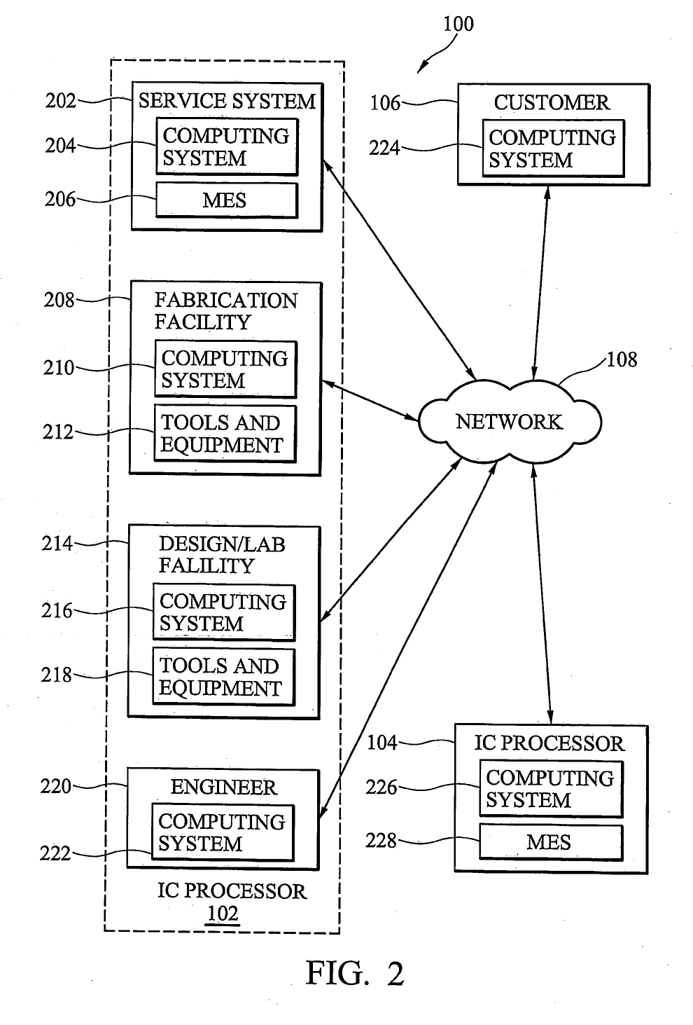

FIG. 2 is a more detailed block diagram of the system 100 of FIG. 1. As shown, the IC processor 102 includes the following entities: a service system 202, a fabrication facility 208, a design/lab facility 214, and an engineering system 220. Each of the entities 202, 208, 214, and 220 includes a respective computing system, and is coupled to one another, to the customer 106, and the IC processor 104 via the network 108. For communicating with the network 108, and with other entities, each of the entities includes a respective network interface (e.g., in association with the respective computing systems). Each of the entities is discussed in more detail below.

The service system 202 is an interface between a customer (e.g., the customer 106) and the IC processor 102, for communicating information about manufacturing operations. For facilitating such communication, the service system 202 includes a computing system 204. The service system 202 also includes a manufacturing execution system (“MES”) 206.

The MES 206 is a distributed computing system including one or more IHS's and one or more software applications. The MES 206 performs various operations to facilitate manufacturing of IC's. For example, the MES 206 collects various real-time information, organizes and stores the information in a centralized database, manages work orders, manages workstations, manages manufacturing processes, tracks inventory, and manages relevant documents. For performing the operations discussed above, the MES 206 is coupled to other systems and entities of the system 100.

The MES 206 is implemented by utilizing one or more of several commercially available products. Such commercially available products include Promis (Books Automations Inc. of Massachusetts), Workstream (Applied Materials, Inc. of California), Poseidon (IBM Corporation of New York), and Mirl-MES (Mechanical Industry Research Laboratories of Taiwan). Each of these products is commonly used for one or more specific applications within the semiconductor manufacturing industry. For example, Mirl-MES is often used in applications involving packaging, liquid crystal displays (“LCD's”), and printed circuit boards (“PCB's”). Promis, Workstream, and Poseidon are often used in IC fabrication and thin film transistor (“TFT”) LCD applications.

The fabrication facility 208 is for fabrication of IC's. Accordingly, the fabrication facility 208 includes fabrication tools and equipment 212. For example, the tools and equipment 212 include an ion implantation tool, a chemical vapor deposition tool, a thermal oxidation tool, a sputtering tool, various optical imaging system, and software for controlling the various tools and equipments. The fabrication facility 208 also includes a computing system 210.

The design/lab facility 214 is for designing and testing of IC's. The design/lab facility 214 includes design/test tools and equipment 218. The tools and equipment 218 include one or more software applications and hardware systems. Similar to other entities discussed above, the design/lab facility 214 includes a computing system 216.

The engineer 220 collaborates in the IC manufacturing process with other entities (e.g., the service system 202, or other engineers). For example, the engineer 220 collaborates with other engineers and the design/lab facility 214 for designing and testing IC's, monitors fabrication processes at the fabrication facility 208, and receives information regarding runs and yields. In at least one embodiment, the engineer 220 also communicates directly with the customer 106. In performing its various operations, the engineer 220 utilizes a computing system 222.

Similar to each of the entities of the IC processor 102, the customer 106 includes a computing system 224. Likewise, the IC processor 104 also includes a computing system 226. The IC processor 104 further includes a MES 228, which performs operations that are substantially similar to those performed by the MES 206 of the IC processor 102. However, the MES 228 performs such operations in the context of the processes (e.g., processes associated with testing and packaging) performed by the IC processor 104.

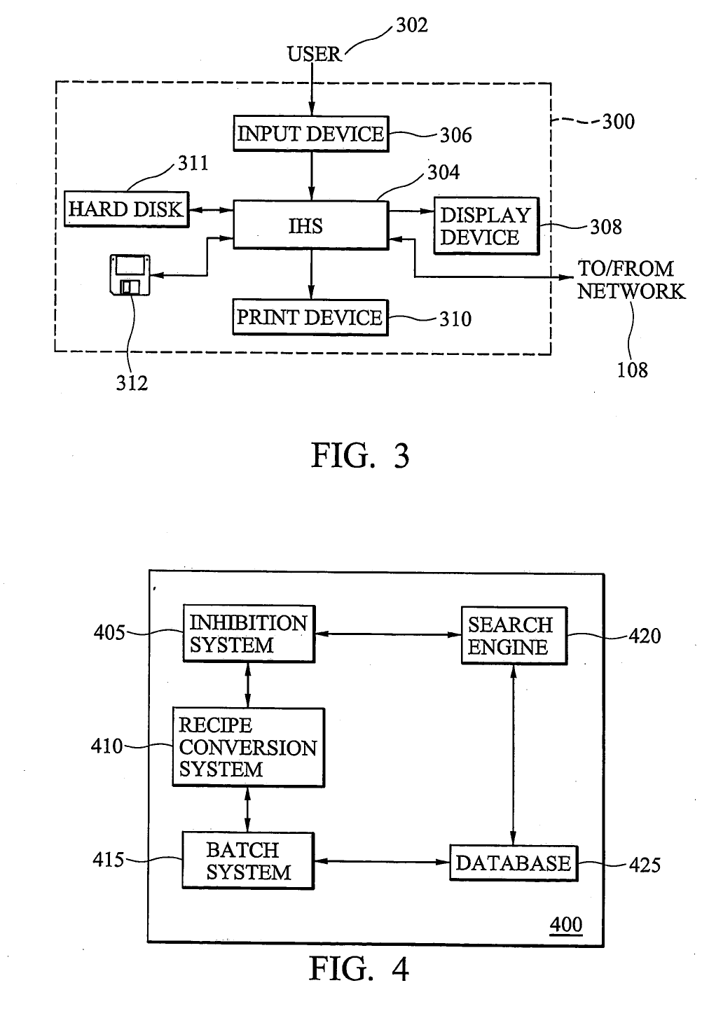

FIG. 3 is a block diagram of a representative one of the computing systems of FIG. 2. Such representative computing system is indicated by a dashed enclosure 300. Each of the computing systems of FIG. 2 operates in association with a respective human user. Accordingly, in the example of FIG. 3, the computing system 300 operates in association with a human user 302, as discussed further below.

As shown in FIG. 3, the computing system 300 includes (a) input devices 306 for receiving information from human user 302, (b) a display device 308 (e.g., a conventional electronic cathode ray tube (“CRT”) device) for displaying information to user 302, (c) an IHS 304 for executing and otherwise processing instructions, (d) a print device 310 (e.g., a conventional electronic printer or plotter), (e) a nonvolatile storage device 311 (e.g., a hard disk drive or other computer-readable medium (or apparatus), as discussed further below) for storing information, (f) a computer-readable medium (or apparatus) 312 (e.g., a portable floppy diskette) for storing information, and (g) various other electronic circuitry for performing other operations of the computing system 300.

For example, the IHS 304 includes (a) a network interface (e.g., circuitry) for communicating between the IHS 304 and the network 108 and (b) a memory device (e.g., random access memory (“RAM”) device and read only memory (“ROM”) device) for storing information (e.g., instructions executed by the IHS 304 and data operated upon by the IHS 304 in response to such instructions). Accordingly, the IHS 304 is connected to the network 108, the input devices 306, the display device 308, the print device 310, the storage device 311, and the computer-readable medium 312, as shown in FIG. 3.

Also for example, in response to signals from the IHS 304, the display device 308 displays visual images, and the user 302 views such visual images. Moreover, the user 302 operates the input devices 306 in order to output information to the IHS 304, and the IHS 304 receives such information from the input devices 306. Also, in response to signals from the IHS 304, the print device 310 prints visual images on paper, and the user 302 views such visual images.

The input devices 306 include, for example, a conventional electronic keyboard and a pointing device such as a conventional electronic “mouse”, rollerball or light pen. The user 302 operates the keyboard to input alphanumeric text information to the IHS 304, and the IHS 304 receives such alphanumeric text information from the keyboard. The user 302 operates the pointing device to input cursor-control information to the IHS 304, and the IHS 304 receives such cursor-control information from the pointing device.

As discussed above, for an IC processor (e.g., the IC processor 102), efficient management and planning of manufacturing resources (e.g., tools and equipment 212) are important. Accordingly, FIG. 4 is a block diagram of a dispatch system, indicated generally at 400. In one example, the dispatch system 400 is included by the MES 205. During a manufacturing process, the dispatch system 400 dispatches a lot of semiconductor components (e.g., wafers or ICs) to one or more manufacturing resources for processing. For clarity, the following discussion references the semiconductor components as being ICs. In dispatching the lot, the dispatch system 400 determines whether the lot is capable of (e.g., uninhibited from) being processed in association with the manufacturing resource. The dispatch system also (a) determines whether a manufacturing process is capable of being performed in association with a recipe, (b) prioritizes lots of ICs for various processes, (c) associates lots of ICs for batch processes and (d) determines an appropriate manufacturing resource to perform a process.

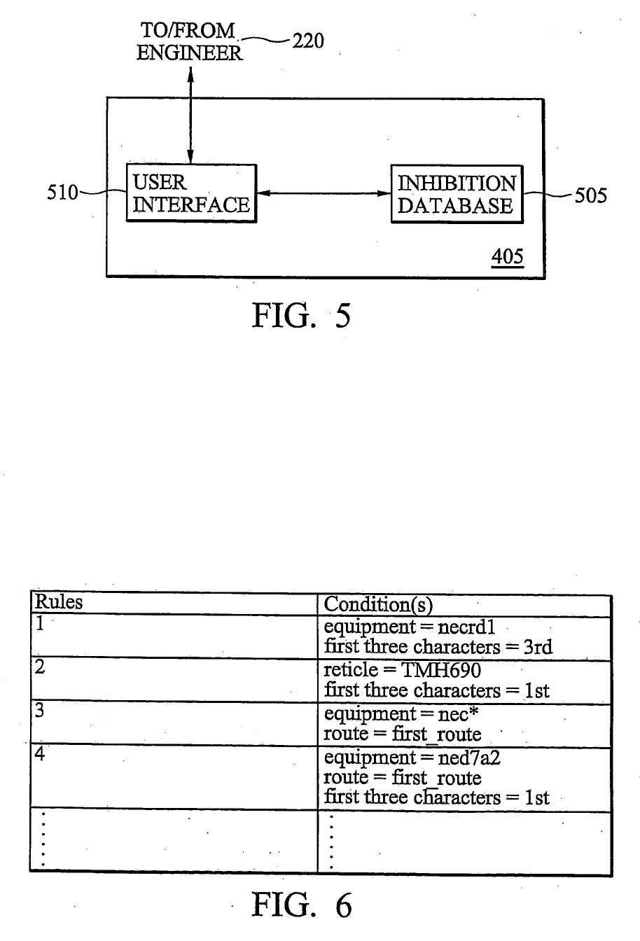

For performing its operations described above, the dispatch system 400 includes an inhibition system 405 (discussed below in more detail in connection with FIG. 5), a recipe conversion system 410, a batch system 415, a search engine 420, and a database 425. The recipe conversion system 410 determines, for example, a recipe that is appropriate for a specified manufacturing process. The batch system 415 associates lots of ICS for batch processes as discussed above. Search engine 420 is operable to search the database 425, which includes various information (e.g., work in process (“WIP”) information) associated with one or more manufacturing processes, in performing the dispatch system 400's operations described herein.

FIG. 5 is a more detailed block diagram of the inhibition system 405. The inhibition system 405 determines whether one or more lots are processable in association with one or more manufacturing resources. In one example, for a specified set of lots and equipment, the inhibition system determines which of the lots in the set of the lots are processable in association with the specified equipment. In making such determination, the inhibition system 405 utilizes rules included by a database.

Accordingly, the inhibition system 405 includes an inhibition database 505. The inhibition database 505 includes a plurality of inhibition rules, and each of the rules includes one or more conditions. FIG. 6 is a table of the plurality of rules, according to the illustrative embodiment. As shown, each of rules 1, 2, 3, and 4 includes one or more respective conditions. Also, for each of the rules, conditions included by the rule are not associated with a single information class. For example, the rule 1 includes two conditions, each of which is respectively associated with equipment and first 3 characters of product identifier. In association with performing a process with the equipment, products having the designated first 3 characters activate the rule 1. Thus, conditions associated with different information class are freely combinable to form a rule.

Each of the lots of ICs processed by the IC processor 102 and/or the IC processor 104 includes its respective manufacturing information (e.g., manufacturing parameters such as equipment, process and stage) that are specified by, for example, an engineer (e.g., the engineer 220). Thus, if the dispatch system 400 applies the rules and determines that a specified lot of ICs includes parameters that satisfy conditions included by a rule, the dispatch system 400 activates (e.g., “triggers”) the rule. In response to triggering the rule, the dispatch system inhibits the lot from being processed.

Referring again to FIG. 5, the inhibition system 405 also includes a user interface 510, coupled to the inhibition database 505, for communicating information with (e.g., receiving information from and outputting information to) the engineer 220. Via the interface 510, the engineer 220 is capable of managing (e.g., adding a new rule and deleting/modifying an existing rule) the plurality of rules included by the inhibition database 505. In one embodiment, in response to the engineer 220 adding a new rule to the inhibition database 505, the dispatch system 400 effectuates the new rule in real time.

In determining whether a lot's manufacturing parameters satisfy a rule (e.g., the rule's conditions), the dispatch system 400 utilizes the search engine 420. In one example, the search engine 420 makes such determination for every lot specified for processing by the IC processor 102. In such an example, for each and every lot of ICs, the search engine 420 determines whether one or more rules are activated by the lot's parameters. The search engine 420, makes such determinations by reducing the quantity (e.g., number) of rules, aggregating lots of ICs with common parameters, and searching using a merge-sort algorithm.

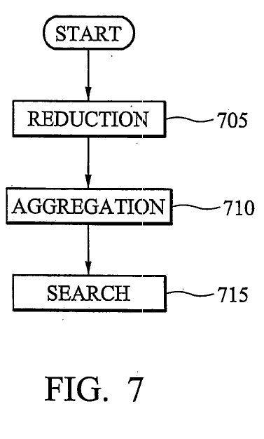

Accordingly, FIG. 7 is a flow chart illustrating operations performed by the search engine 420. The operation begins at a step 705, where the search engine 420 reduces the quantity of the rules to be searched by eliminating rules that are determined to be substantially irrelevant (e.g., inapplicable) for a specified dispatching decision. For example, referring again to FIG. 6, if a dispatching decision includes determining which of the lots are capable being processed by equipment identified by necrd1, the search engine 420 removes (e.g., eliminates) the rules 2 and 4 because the rules 2 and 4 do not include a condition which states that equipment is necrd1. Thus, the search engine 420 determines that rules 2 and 4 are irrelevant for this dispatching decision. By eliminating the irrelevant rules, a plurality of remaining rules is formed. Notably, the search engine 420 does not eliminate the rule 3 because an asterisk is a “wild card” character. After the step 705, the operation continues to a step 710.

At the step 710, the search engine 420 aggregates lots with commonalities (e.g., one or more common fields in their parameters, such manufacturing parameters). In one example, the search engine 420 associates all lots having a common equipment identification with a group. Accordingly, for a dispatching decision involving the common equipment identification, the search engine 420 searches the rules once using parameters of a particular lot in the group, and ascribes a result of the search to all lots in the group. After the step 710, the operation continues to a step 715.

At the step 715, in response to a dispatching decision, the search engine 420 searches the rules with respect to parameters of the lots of ICs using a conventional merge-sort algorithm. By using the merge-sort algorithm, the search engine 420 reduces an amount of comparisons needed for each search operation in making a dispatch decision.

Although illustrative embodiments have been shown and described, a wide range of modification, change, and substitution is contemplated in the foregoing disclosure and, in some instances, some features of the embodiments may be employed without a corresponding use of other features. Accordingly, broad constructions of the appended claims in manner consistent with the scope of the embodiments disclosed are appropriate.

What is claimed is:

1. A method for dispatching semiconductor components for processing, the method comprising:
providing a plurality of lots of semiconductor components;
providing a plurality of rules, each including one or more conditions;
determining which of the plurality of rules is applicable to a particular lot;
eliminating rules that are not applicable to a particular lot, thus forming a plurality of remaining rules for each particular lot;
applying the plurality of remaining rules to the lots of semiconductor components; and
if a rule applied to a particular lot activates, inhibiting the processing of the particular lot.

2. The method of claim 1, wherein the semiconductor components are semiconductor wafers.

3. The method of claim 1, wherein the semiconductor components are semiconductor integrated circuits (“ICs”).

4. The method of claim 1, wherein a rule activates if a lot's parameters satisfy one or more conditions of the rule.

5. The method of claim 1, wherein at least one of the conditions is associated with a piece of equipment.

6. The method of claim 1, wherein at least one of the conditions is associated with a process stage.

7. The method of claim 1, wherein the applying the plurality of remaining rules includes:
searching the conditions of the rules via a merge-sort algorithm.

8. A method for dispatching semiconductor components for processing, the method comprising:
providing a plurality of lots of semiconductor components;
associating two or more lots in the plurality of lots into a group of lots having a common manufacturing parameter;
providing a plurality of rules, each including one or more conditions;
applying the plurality of rules to a particular lot in the group of lots; and
if a rule applied to the particular lot activates, inhibiting the processing of all lots in the group of lots.

9. The method of claim 8, wherein the semiconductor components are semiconductor wafers.

10. The method of claim 8, wherein the semiconductor components are semiconductor integrated circuits (“ICs”).

11. The method of claim 8, wherein the common manufacturing parameter includes a parameter related to a piece of equipment.

12. The method of claim 8, wherein the common manufacturing parameter includes a parameter related to a process stage.

13. The method of claim 8, wherein the applying the plurality of rules includes:
searching the conditions of the rules via a merge-sort algorithm.

14. A system for dispatching a plurality of lots of semiconductor components, the system comprising:
an information handling system (“IHS”) for:
storing a plurality of rules, each including one or more conditions;
determining which of the plurality of rules is applicable to a particular lot;
eliminating rules that are not applicable to a particular lot, thus forming a plurality of remaining rules for each particular lot;
applying the plurality of remaining rules to the lots of semiconductor components; and
if a rule applied to a particular lot activates, inhibiting the processing of the particular lot.

15. The system of claim 14, wherein the semiconductor components are semiconductor wafers.

16. The system of claim 14, wherein the semiconductor components are semiconductor integrated circuits (“ICs”).

17. The system of claim 14, wherein a rule activates if a lot's parameters satisfy one or more conditions of the rule. 3.

18. The system of claim 14, wherein at least one of the conditions is associated with a piece of equipment.

19. The system of claim 14, wherein at least one of the conditions is associated with a process stage.

20. The system of claim 14, wherein the applying the plurality of remaining rules includes:
searching the conditions of the rules via a merge-sort algorithm.

21. A system for dispatching a plurality of lots of semiconductor components, the system comprising:
an information handling system (“IHS”) for:
associating two or more lots in the plurality of lots into a group of lots having a common manufacturing parameter;
providing a plurality of rules, each including one or more conditions;
applying the plurality of rules to a particular lot in the group of lots; and
if a rule applied to the particular lot activates, inhibiting the processing of all lots in the group of lots.

22. The system of claim 21, wherein the semiconductor components are semiconductor wafers.

23. The system of claim 21, wherein the semiconductor components are semiconductor integrated circuits (“ICs”).

24. The system of claim 21, wherein the common manufacturing parameter includes a parameter about a piece of equipment.

25. The system of claim 21, wherein the common manufacturing parameter includes a parameter about a process stage

26. The system of claim 21, wherein the applying the plurality of rules includes:
searching the conditions of the rules via a merge-sort algorithm.
